(19) United States
(12) Patent Application Publication
(10) Pub. No.: US 2010/0103175 A1
(43) Pub. Date: Apr. 29, 2010

(54) METHOD FOR GENERATING A HIGH-RESOLUTION VIRTUAL-FOCAL-PLANE IMAGE

(75) Inventors: Masatoshi Okutomi, Tokyo (JP); Kaoru Ikeda, Tokyo (JP); Masao Shimizu, Tokyo (JP)

Correspondence Address: NIXON PEABODY, LLP, 401 9TH STREET, NW, SUITE 900, WASHINGTON, DC, 20004-2128, US

(73) Assignee: TOKYO INSTITUTE OF TECHNOLOGY, Meguro-Ku, Tokyo (JP)

(21) Appl. No.: 12/443,844

(22) PCT Filed: Oct. 25, 2007
(86) PCT No.: PCT/JP2007/071274

§ 371 Date: Apr. 1, 2009

(30) Foreign Application Priority Data
Oct. 25, 2006 (JP) 2006-290009

(51) Int. Cl. G06T 17/00

(52) U.S. Cl. 345/428

(57) ABSTRACT

The present invention provides a method for generating a high-resolution virtual-focal-plane image which is capable of generating a virtual-focal-plane image with an arbitrary desired resolution simply and rapidly by using multi-view images.

The method of the present invention comprises a disparity estimating process step for estimating disparities by performing the stereo matching for multi-view images consisting of multiple images with different capturing positions and obtaining a disparity image; a region selecting process step for selecting an image among multi-view images as a basis image, setting all remaining images as reference images, and selecting a predetermined region on the basis image as a region of interest; a virtual-focal-plane estimating process step for estimating a plane in the disparity space for the region of interest based on the disparity image, and setting the estimated plane as a virtual-focal-plane; and an image integrating process step for obtaining image deformation parameters used for deforming each reference image to the basis image for the virtual-focal-plane, and generating the virtual-focal-plane image by deforming multi-view images with obtained image deformation parameters.

### TECHNICAL FIELD

The present invention relates to an image generating method for generating a new high-resolution image by using multiple images captured from multiple view points (multi-view images), i.e. multiple images with different capturing positions.

### BACKGROUND TECHNIQUE

Conventionally, a method to generate an image with high image quality (a high-quality image) by combining multiple images is known. For example, the super-resolution processing is known as a method for obtaining a high-resolution image from multiple images with different capturing positions (see Non-Patent Document 1).

Further, a method that reduces noises by obtaining the correspondence relation between pixels from the disparity obtained by stereo matching and then averaging the corresponding pixels and synthesizing it, is also proposed (see Non-Patent Document 2). This method is capable of improving the accuracy of disparity estimation by the multi-camera stereo processing (see Non-Patent Document 3) and also improves the effect of the image quality improvement. Moreover, this method is capable of the high-resolution processing by obtaining the disparity with sub-pixel accuracy (see Non-Patent Document 4).

On the other hand, according to a method proposed by Wilburn et al. (see Non-Patent Document 5), it is possible to perform processes such as a process generating a panoramic image with a broad field of view and a process improving the dynamic range by combining images captured by a camera array. Further, by using the method disclosed in Non-Patent Document 5, it is also possible to generate an image that capturing is different with an ordinary monocular camera, for example, it can synthesize an image with a shallow depth of field and a large aperture artificially.

Moreover, Vaish et al. (see Non-Patent Document 6) proposed a method capable of generating not only an image with a shallow depth of field but also an image that can not be captured by a camera with an ordinary optical system and has a focus on a plane which is not straight toward the camera, by combining images captured by a camera array likewise.

However, in the method disclosed in Non-Patent Document 6, in order to generate a virtual-focal-plane image, it is necessary to manually and sequentially calibrate the position of the focal plane which a user needs (i.e. the plane that is a focused plane on the image, hereinafter simply referred to as “a virtual-focal-plane”), and it is also necessary to sequentially estimate parameters that are necessary to generate the virtual-focal-plane image.

That is to say, to generate the virtual-focal-plane image by using the method disclosed in Non-Patent Document 6, operations that take many times, i.e. an operation of “the sequential calibration” of the position of the virtual-focal-plane and an operation of “the sequential estimation” of the necessary parameters, are necessary. Therefore, there is a problem that it is impossible to generate the virtual-focal-plane image rapidly in the method disclosed in Non-Patent Document 6.

Further, since the resolution of the virtual-focal-plane image generated by the method disclosed in Non-Patent Document 6, is equal to the resolution of images before the generation, i.e. images captured by a camera array, there is a problem that it is impossible to realize the high-resolution processing of the image.

### DISCLOSURE OF THE INVENTION

The present invention has been developed in view of the above described circumstances, and an object of the present invention is to provide a method for generating a high-resolution virtual-focal-plane image which is capable of generating a virtual-focal-plane image with an arbitrary desired resolution simply and rapidly by using multi-view images captured from multiple different view points for a capturing object.

The present invention relates to a method for generating a high-resolution virtual-focal-plane image which generates a virtual-focal-plane image by using one set of multi-view images consisting of multiple images obtained from multiple different view points. The above object of the present invention is effectively achieved by the constitution that with respect to an arbitrary predetermined region, said virtual-focal-plane image is generated by performing a deformation so that each image of said multi-view images overlaps. Further, the above object of the present invention is also effectively achieved by the constitution that disparities are obtained by performing the stereo matching for said multi-view images, and said deformation are obtained by using said obtained disparities. Further, the above object of the present invention is also effectively achieved by the constitution that said deformation utilizes a two-dimensional homography for overlapping two images. Further, the above object of the present invention is also effectively achieved by the constitution that said deformation is performed for said multiple images consisting of said multi-view images, said deformed multiple images are integrated, an integrated pixel group is sectioned with a lattice having an arbitrary size, said virtual-focal-plane image with an arbitrary resolution is generated by setting said lattice as a pixel.

Further, the above object of the present invention is also effectively achieved by the constitution that a method for generating a high-resolution virtual-focal-plane image which generates a virtual-focal-plane image by using one set of multi-view images consisting of multiple images captured from multiple different view points for a capturing object, said method characterized in comprising: a disparity estimating process step for estimating disparities by performing the stereo matching for said multi-view images and obtaining a disparity image; a region selecting process step for selecting an image among said multiple images consisting of said multi-view images as a basis image, setting all remaining images except said basis image as reference images, and selecting a predetermined region on said basis image as a region of interest; a virtual-focal-plane estimating process step for estimating a plane in the disparity space for said region of interest based on said disparity image, and setting said estimated plane as a virtual-focal-plane; and an image integrating process step for obtaining image deformation parameters that are used for deforming said each reference image to said basis image for said virtual-focal-plane, and generating said virtual-focal-plane image by deforming said multi-view images with said obtained image deformation parameters. Further, the above object of the present invention is also effectively achieved by the constitution that said multi-view images are obtained by a camera group that consists of multiple cameras and has a two-dimensional arrangement. Further, the above object of the present invention is also effectively achieved by the constitution that an image capture device is fixed on a moving means, said multi-view images are images captured by moving said image capture device after assuming a camera group that consists of multiple cameras and has a two-dimensional arrangement. Further, the above object of the present invention is also effectively achieved by the constitution that in said virtual-focal-plane estimating process step, edges in the image belonging to said region of interest of said basis image are extracted, a plane in the disparity space for said region of interest is estimated by only using disparities obtained in parts existing said edges, said estimated plane is set as said virtual-focal-plane. Further, the above object of the present invention is also effectively achieved by the constitution that said image integrating process step comprises a first step for obtaining the disparity corresponding to each vertex of said region of interest on said basis image; a second step for obtaining coordinate positions of corresponding points of said reference image that correspond to each vertex of said region of interest on said basis image; a third step for obtaining a homography matrix that overlaps these coordinate pairs from the correspondence relation of two vertices; a fourth step for obtaining said homography matrix that gives the transformation for overlapping two planes by performing processes of said second step and said third step with respect to all reference images; and a fifth step for performing the image integrating process by deforming each reference image with the obtained homography matrix, sectioning the integrated pixel group with a lattice having a predetermined size, and generating said virtual-focal-plane image with a resolution determined by said predetermined size of said lattice by setting said lattice as a pixel.

### BRIEF DESCRIPTION OF THE DRAWINGS

FIG. 1 is a conceptual diagram illustrating an example of the camera arrangement (a 25-lens stereo camera with a lattice arrangement) for obtaining “multi-view images” that are used in the present invention;

FIG. 2 is a diagram showing an example of one set of multi-view images that are captured by the 25-lens stereo camera illustrated in FIG. 1;

FIG. 3(A) shows an image captured from a camera which is located in the center of the lattice arrangement of the 25-lens stereo camera illustrated in FIG. 1, i.e. a central image of FIG. 2;

FIG. 3(B) shows a disparity map obtained by the multi-camera stereo three-dimensional measurement that used the image of FIG. 3(A) as a basis image;

FIG. 4 is a conceptual diagram illustrating the object arranging relation and the arrangement of the virtual-focal-plane in the capturing scene of the multi-view images of FIG. 2;

FIG. 5 shows virtual-focal-plane images with virtual-focal-planes having different positions that are synthesized based on the multi-view images of FIG. 2, FIG. 5(A) shows a virtual-focal-plane image that is synthesized in the case of putting the virtual-focal-plane at the position of (a) that is indicated by a dotted line of FIG. 4, FIG. 5(B) shows a virtual-focal-plane image that is synthesized in the case of putting the virtual-focal-plane at the position of (b) that is indicated by a dotted line of FIG. 4;

FIG. 6 shows a virtual-focal-plane image with the virtual-focal-plane having an arbitrary position that is synthesized based on the multi-view images of FIG. 2, that is to say, the image shown in FIG. 6 is a virtual-focal-plane image in the case of putting the virtual-focal-plane at the position of (c) that is indicated by a dotted line of FIG. 7;

FIG. 7 is a conceptual diagram illustrating the object arranging relation and the arrangement of an arbitrary virtual-focal-plane in the capturing scene of the multi-view images of FIG. 2;

FIG. 8 is a conceptual diagram illustrating an outline of processes for generating the virtual-focal-plane image according to the present invention;

FIG. 9 is a conceptual diagram illustrating the relation between the generalized disparity and the homography matrix in “a calibration using two planes” that is used in a disparity estimating process of the present invention;

FIG. 10 shows an example of the disparity estimating result obtained by the disparity estimating process of the present invention, FIG. 10(A) shows a basis image and FIG. 10(B) shows a disparity map, further, FIG. 10(C) shows a graph which plots disparities (green dots) corresponding to rectangle regions that are indicated in FIG. 10(A) and FIG. (B) and disparities (red dots) on the edge that are used in a plane estimating;

FIG. 11 is a conceptual diagram illustrating geometric relations in real space that are used in the present invention;

FIG. 12 is a conceptual diagram illustrating the estimation of a homography matrix for overlapping two planes in an image integrating process of the present invention;

FIG. 13 is a conceptual diagram illustrating the high-resolution processing based on the combination of images in the image integrating process of the present invention;

FIG. 14 illustrates setting conditions of the experiment using the synthesized stereo images, rectangle regions 1 and 2 of FIG. 14(A) correspond to the processing region (region of interest) in each experiment result indicated in FIG. 16;

FIG. 15 shows the synthesized 25-camera images.

FIG. 16 shows the results of experiments using the synthesized 25-camera stereo images shown in FIG. 15;

FIG. 17 shows real 25-camera images;

FIG. 18 shows the results of experiments using real 25-camera images shown in FIG. 17;

FIG. 19 shows an original basis image (a ISO12233 resolution chart); and

FIG. 20 shows experiment results of real images based the original basis image shown in FIG. 19.

### THE BEST MODE FOR CARRYING OUT THE INVENTION

The present invention relates to a method for generating a high-resolution virtual-focal-plane image which is capable of generating a virtual-focal-plane image with a desired arbitrary resolution simply and rapidly by using multiple images (hereinafter referred to as “multi-view images”) captured from multiple different view points for a capturing object.

The following is a description of preferred embodiments for carrying out the present invention, with reference to the accompanying drawings.

### <1> Virtual-Focal-Plane Image

Firstly, we describe the point aimed at a method for generating a high-resolution virtual-focal-plane image according to the present invention and “a virtual-focal-plane image” that is a new image and is generated by the method for generating a high-resolution virtual-focal-plane image according to the present invention in detail as follows.

### <1-1> Virtual-Focal-Plan Parallel to Capturing Plane

In the present invention, in order to generate “the virtual-focal-plane image”, at first, it is necessary to obtain one set of multi-view images by capturing the capturing object from multiple view points.

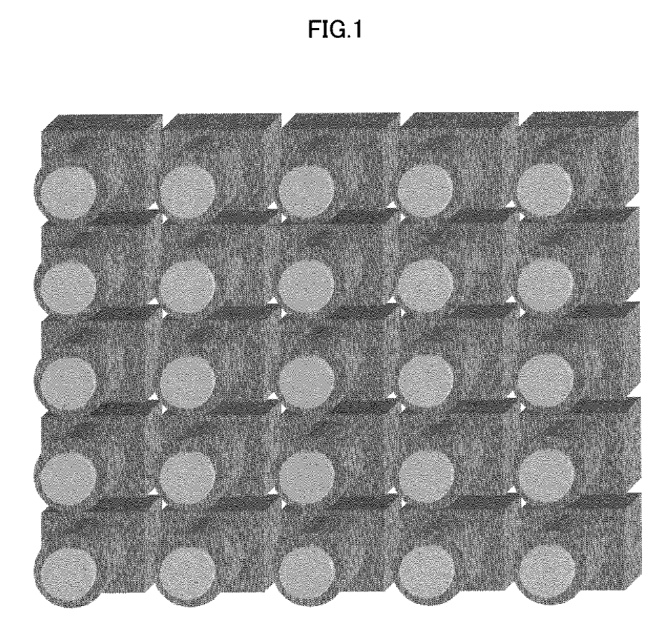

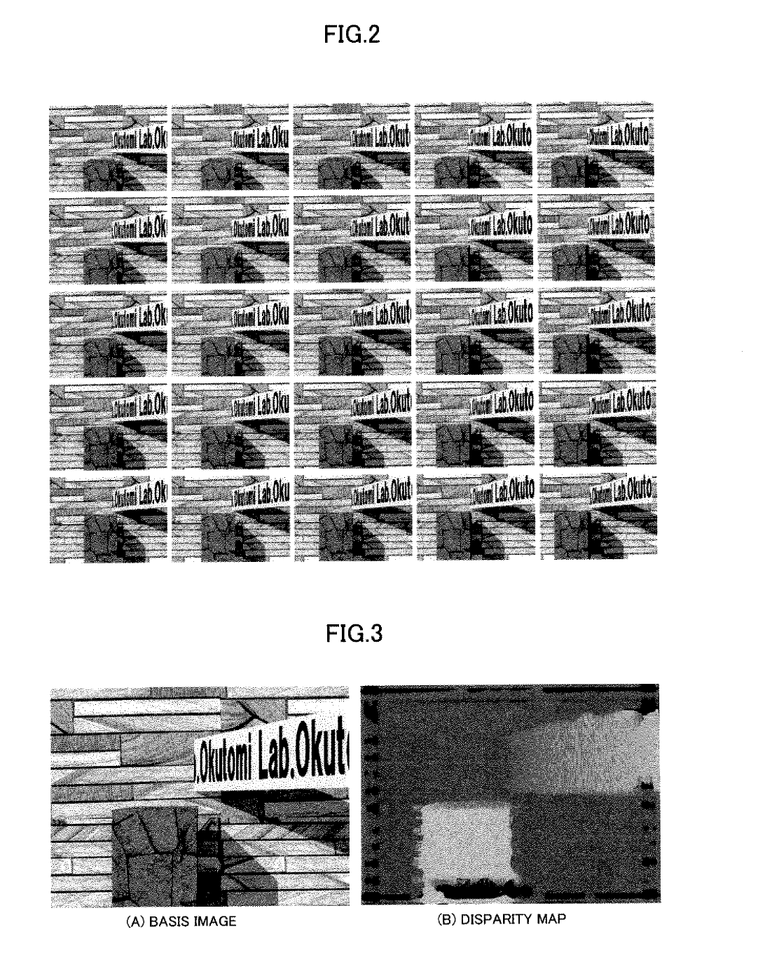

For example, these multi-view images can be obtained by using a 25-lens stereo camera with the lattice arrangement shown in FIG. 1 (hereinafter also referred to as “a camera array”). FIG. 2 shows an example of multi-view images that are captured by the 25-lens stereo camera of FIG. 1.

In this time, by using an image captured from the camera which is located in the center of the lattice arrangement shown in FIG. 1 as a basis image (see FIG. 3(A)), and then performing the multi-camera stereo three-dimensional measurement for the multi-view images shown in FIG. 2, it is possible to obtain a disparity map (hereinafter also referred to as “a disparity image”) shown in FIG. 3(B).

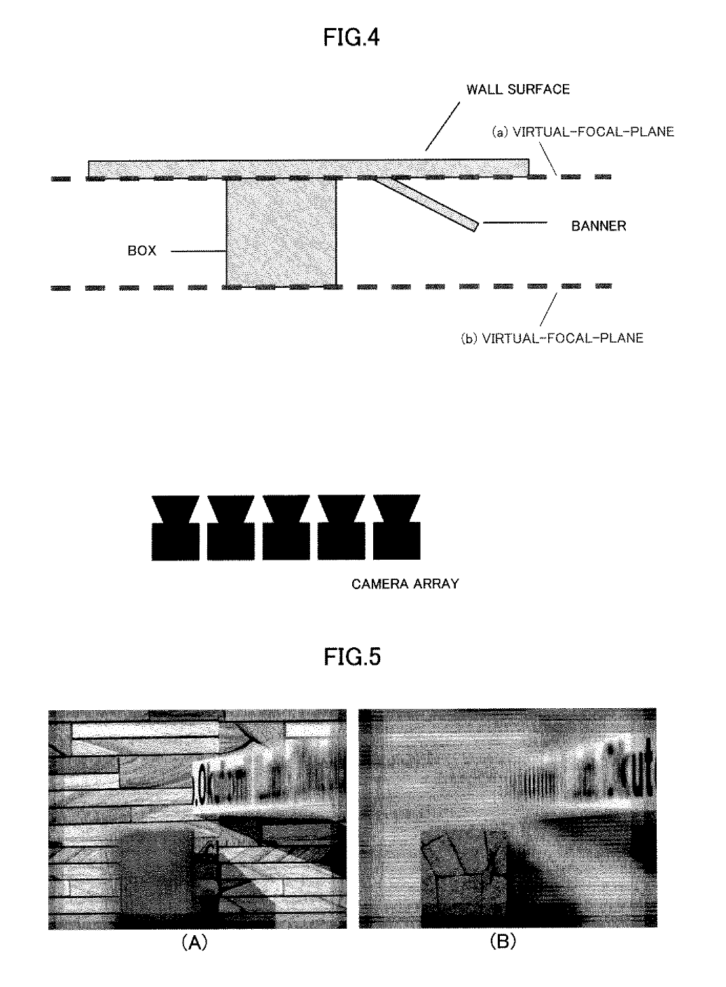

In this time, when the object arranging relation and the arrangement of the virtual-focal-plane in the capturing scene of the multi-view images shown in FIG. 2, is represented conceptually, it seems to become FIG. 4. By comparing these, it is clear that the disparity corresponds to the depth in the real space, and an object existing in the position that is near to the camera has a big disparity value, an object existing in the position that is away from the camera has a small disparity value. Moreover, objects existing in the same depth have the same disparity value. A plane in the real space that the values of the disparity become same, becomes a fronto-parallel plane for the camera.

Here, since the disparity represents the displacement of a reference image and a basis image, with respect to a point existing in a certain depth, by using the corresponding disparity, it is possible to perform the deformation so that all reference images are overlapped on the basis image. “Reference images” saying here, mean all images remaining among multiple images consisting of one set of multi-view images except an image that is selected as the basis image.

FIG. 5 shows an example of the virtual-focal-plane image that is synthesized based on the multi-view images of FIG. 2 by using the method that with respect to a point existing in a certain depth, by using the corresponding disparity, the deformation is performed so that all reference images are overlapped on the basis image. FIG. 5(A) is an example in the case of deforming with the disparity corresponding to the inner wall surface and synthesizing the virtual-focal-plane image. Further, FIG. 5(B) is an example in the case of deforming with the disparity corresponding to the front of the box and synthesizing the virtual-focal-plane image.

In the present invention, a virtual focal plane that occurs in correspondence with the disparity that attracts attention in this time, is called as “a virtual-focal-plane”, and then an image that is synthesized for the virtual-focal-plane, is called as “a virtual-focal-plane image”. FIG. 5(A) and FIG. 5(B) are virtual-focal-plane images in the cases of putting the virtual-focal-plane at the inner wall surface and putting the virtual-focal-plane at the front of the box, respectively. That is to say, FIG. 5(A) shows a virtual-focal-plane image that is synthesized in the case of putting the virtual-focal-plane at the position of (a) that is indicated by a dotted line of FIG. 4. Further, FIG. 5(B) shows a virtual-focal-plane image that is synthesized in the case of putting the virtual-focal-plane at the position of (b) that is indicated by a dotted line of FIG. 4.

In general, an image with a shallow depth of field, focuses on the depth that the object with the highest interest exists in the image. In this time, for the object that becomes the focusing subject, it is possible to obtain an image with high sharpness and high image quality, and in other unnecessary depth, the obtained image is a blurred image. “The virtual-focal-plane image” also has the property that resembles this, the image sharpness is high on the virtual-focal-plane, and blurs occur in the image as becoming a point that is away from the virtual-focal-plane. Further, on the virtual-focal-plane, it is possible to obtain an effect like capturing multiple images of the same scene by using multiple different cameras. Therefore, it is possible to reduce noises and obtain an image with improved image quality. Moreover, since it is possible to perform the sub-pixel displacement estimation of a basis image and a reference image by performing the sub-pixel disparity estimation, it is also possible to obtain the effect of the high-resolution processing.

### <1-2> Arbitrary Virtual-Focal-Plane

In <1-1>, “the virtual-focal-plane” is regarded as a thing existing on a certain depth. However generally, in the case that a user is going to get some kind of information from an image, the region of interest is not limited to existing on a fronto-parallel plane for the camera.

For example, in the scene shown in FIG. 3(A), when attention is paid to characters on a banner that is arranged diagonally, the information of characters to need, exists in a plane that is not a fronto-parallel plane for the camera.

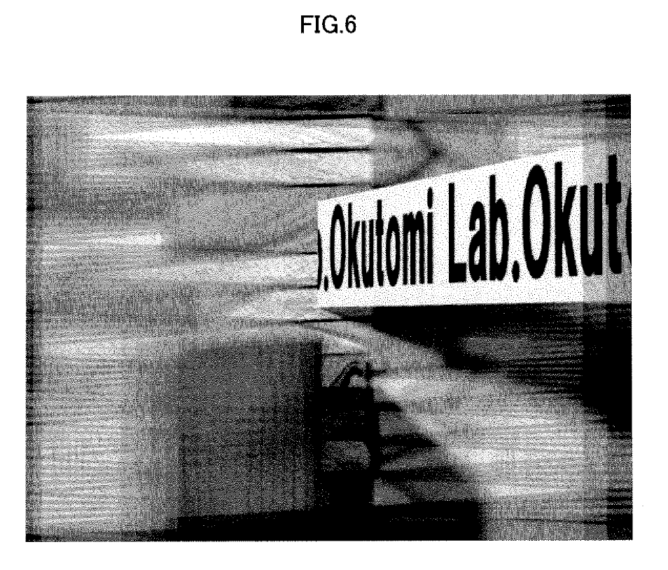

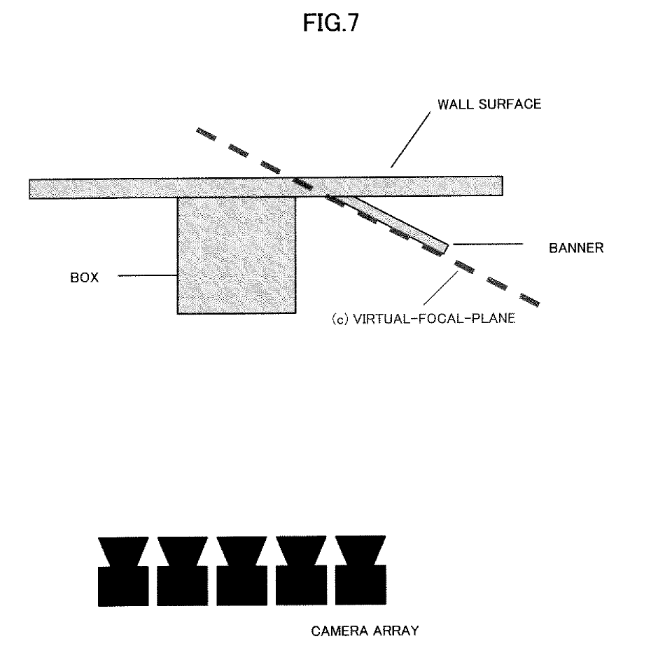

So in the present invention, a virtual-focal-plane image having a virtual-focal-plane in an arbitrary designated region on an image, is generated as shown in FIG. 6. In the case of the virtual-focal-plane image having an arbitrary virtual-focal-plane shown in FIG. 6, FIG. 7 shows the arrangement of the arbitrary virtual-focal-plane. From FIG. 7, it is clear that in the case of putting the virtual-focal-plane at the position of (c) that is indicated by a dotted line, since the virtual-focal-plane is a plane that is not a fronto-parallel plane for the camera, that is to say, the virtual-focal-plane is an arbitrary virtual-focal-plane.

“The virtual-focal-plane image” generated by the present invention, is not limited to a fronto-parallel plane for the camera, and assumes an arbitrary plane in the space as a focal plane. That is to say, “the virtual-focal-plane image” generated by the present invention can be said to be an image that focuses on an arbitrary plane on the image.

It is difficult to capture “a virtual-focal-plane image” generated by the present invention unless a camera that light receiving elements are not perpendicular to the optical axis of the lens is used. It is impossible to capture an image that is focused on an arbitrary plane by using an ordinary camera with the fixed optical system.

Further, an image with a virtual-focal-plan parallel to the capturing plane described in <1-1>, can be said to be “a virtual-focal-plane image” generated by using the present invention in a special case that a focal plane which is set arbitrarily becomes parallel to the capturing plane. From this thing, a virtual-focal-plane image with an arbitrary virtual-focal-plane described here, has a more generality.

In short, “a virtual-focal-plane image” generated by a method for generating a high-resolution virtual-focal-plane image of the present invention, is an image with an arbitrary virtual-focal-plane (hereinafter referred to as “a generalized virtual-focal-plane image” or “a virtual-focal-plane image”).

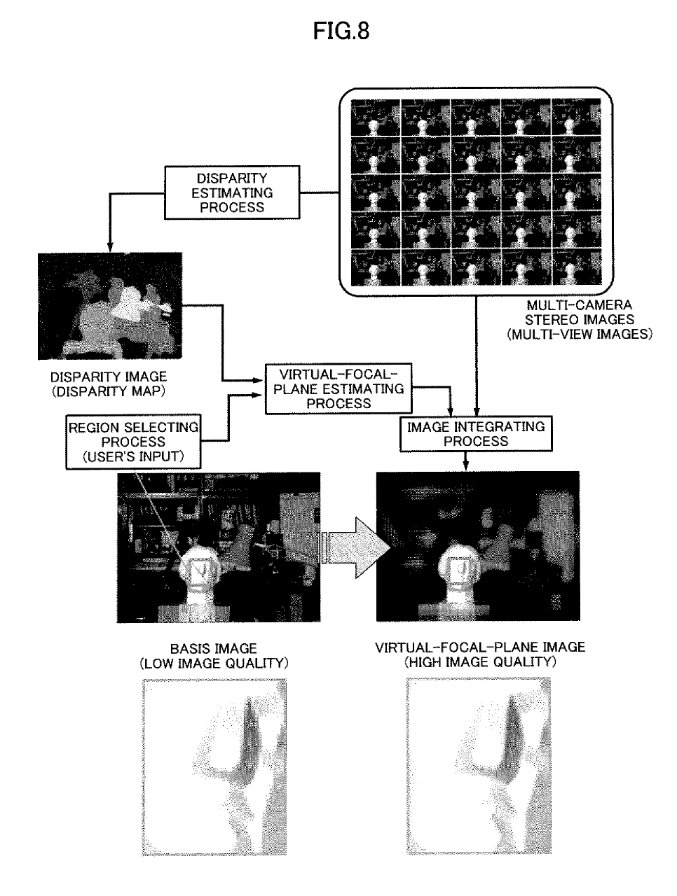

FIG. 8 conceptually shows an outline of processes for generating the generalized virtual-focal-plane image according to the present invention. As shown in FIG. 8, in the present invention, firstly, one set of multi-view images consisting of multiple images with different capturing positions (for example, multi-camera stereo images captured by a 25-lens camera array with a two-dimensional arrangement) are obtained.

And then, by performing the stereo matching (i.e. the stereo three-dimensional measurement) for the obtained multi-view images, a process (a disparity estimating process) that estimates the disparity of the object scene and obtains a disparity image (hereinafter also simply referred to as “a disparity map”), is performed.

Next, with respect to an image that is selected as a basis image from multiple images consisting of multi-view images, a user designates an arbitrary region on the image where the user wants to pay attention to. That is to say, “a region selecting process” that selects the desired arbitrary region on the basis image as “a region of interest”, is performed.

And then, “a virtual-focal-plane estimating process” is performed. “The virtual-focal-plane estimating process” first estimates a plane in the disparity space for “the region of interest” designated by “the region selecting process” based on “the disparity image” obtained by “the disparity estimating process”, and then sets the estimated plane as “a virtual-focal-plane”.

Finally, “an image integrating process” is performed. “The image integrating process” first obtains “image deformation parameters” that represent the correspondence relation between images and are used for deforming all images consisting of multi-view images for “the virtual-focal-plane” estimated by “the virtual-focal-plane estimating process”, and then generates “a virtual-focal-plane image” with a higher image quality than the basis image by deforming all images consisting of multi-view images with the obtained “image deformation parameters”.

Along the processing flow as described above, the present invention generates the virtual-focal-plane image with high image quality and an arbitrary desired virtual-focal-plane from the multi-view images with low image quality. That is to say, according to the present invention, it is possible to synthesize an image that is focused on an arbitrary region of interest designated on the image and has high image quality based on the multi-view images with low image quality.

### <2> Virtual-Focal-Plane Image Generating Process Using Multi-View Images in the Present Invention

We explain the method for generating a high-resolution virtual-focal-plane image of the present invention more concretely as follows.

### <2-1> Disparity Estimating Process in the Present Invention

Firstly, we explain the disparity estimating process in the present invention (i.e. the disparity estimating process of FIG. 8) more concretely.

### <2-1-1> Calibration Using Two Planes

The disparity estimating process of the present invention is a process that estimates disparities by searching the corresponding point of the reference image for the basis image with the multi-view images (the multi-camera stereo images), and obtains the disparity image (the disparity map).

In this time, “the calibration using two planes” disclosed in Non-Patent Document 7 is carried out between stereo cameras, and the calibration plane is set to be perpendicular to the optical axis of a basis camera. “The basis camera” saying here means a camera that captures the basis image.

In “the calibration using two planes” disclosed in Non-Patent Document 7, with respect to two certain planes in space that become the object of the stereo three-dimensional measurement, the relation between images is obtained in the form of the homography matrix that matches two planes.

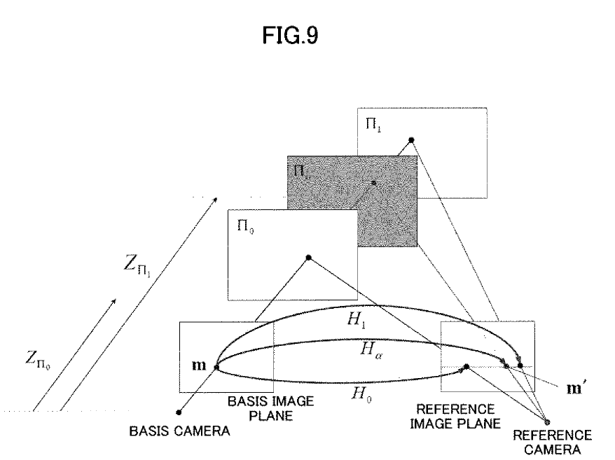

That is to say, as shown in FIG. 9, in the case of setting the two planes to Π₀,Π₁ respectively, the homography matrix that gives the relation between images on each plane becomes H₀, H₁.

In the disparity estimating process of the present invention, a homography matrix H_{α} that is derived from the calibration using the two planes and is represented by the following Expression 1, is used.

H_{α}=(1−α)H₀+αH₁ [Expression 1]

In this time, α is called as “a generalized disparity”, hereinafter this α is also simply referred to as “a disparity”.

Here, with respect to a certain disparity α, the reference image is deformed by using the homography matrix H_{α} obtained from Expression 1. That is to say, the deformation that is performed by the homography matrix H_{α} so that the reference image is overlapped on the basis image, can be represented by the following Expression 2.

\tilde{m}˜H_{α} [symbol] [Expression 2]

Where, \tilde{m} represents homogenous coordinates of coordinates m in the basis image. Further, [symbol] represents homogenous coordinates of coordinates m′ in the reference image. Moreover, the symbol ˜ represents an equivalence relation, and means that both sides permit the difference of the constant factor and are equal.

### <2-1-2> Disparity Estimating Process

From the above Expressions 1 and 2, it is clear that the deformation given by Expression 2 (i.e. the deformation that is performed so that the reference image is overlapped on the basis image), is changed only by the generalized disparity α based on Expression 1.

Hence, a value of each pixel of the basis image is compared to that of the deformed reference image while changing the value of α, and the value of α that the value of each pixel of the basis image comes to accord with that of the deformed reference image, is searched. By this, it is possible to estimate the generalized disparity α.

Moreover, an area-based scheme using SSD (Sum of Squared Difference) is used in the evaluated value of comparison of pixel values. And further, SSSD (Sum of Sum of Squared Difference) is used in the integration of results using multi-camera stereo images (see Non-Patent Document 3).

According to the disparity estimating process of the present invention as described above, it is possible to estimate a dense disparity map (disparity image) for all pixels in the image by using multi-camera stereo images (multi-view images).

### <2-2> Virtual-Focal-Plane Estimating Process in the Present Invention

Secondly, we explain the virtual-focal-plane estimating process in the present invention (i.e. the virtual-focal-plane estimating process of FIG. 8) more concretely.

In the virtual-focal-plane estimating process of the present invention, “a region of interest” selected by the user from the basis image (hereinafter “the region of interest” is also referred to as “a processing region”) is obtained by “the region selecting process” described in <1-2>, a plane in the disparity space where points within the region of interest exist is obtained, and the obtained plane is set as the virtual-focal-plane.

In the present invention, it is assumed that points existing within the region of interest (the processing region) designated by the user, are points existing in the approximately same plane in the real space.

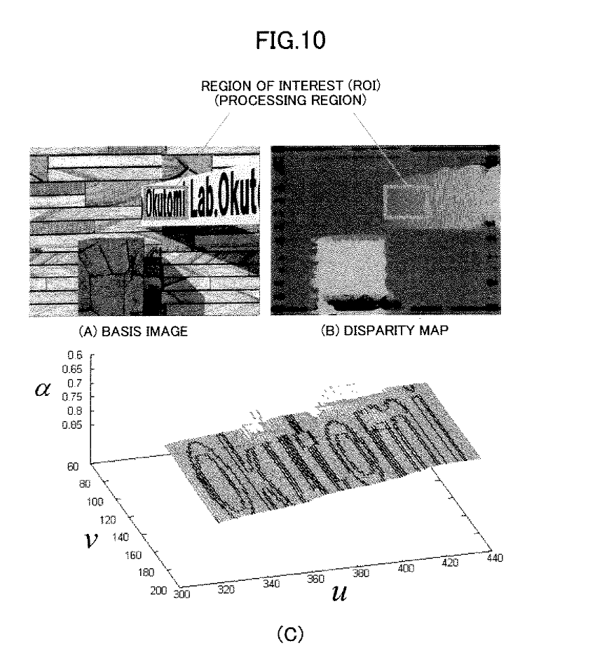

FIG. 10 is an example of the disparity estimating result obtained by the disparity estimating process described in <2-1>. Further, the region of interest (the processing region) designated by the user, is a rectangle range indicated by a green solid line in the basis image of FIG. 10(A). The region of interest is also indicated by a green solid line in the disparity map of FIG. 10(B).

As shown in FIG. 10, the disparity map within the processing region, exists in the same plane in the disparity space (u, v, α). Where (u, v) represents two axes on the image and α is the disparity.

In this time, the set of points existing the same plane in the disparity space, can be regarded as existing the same plane in the real space. With respect to that reason, i.e. with respect to the relation between the real space and the disparity space, we will hereinafter describe in detail.

From this thing, the region in the disparity space corresponding to the plane of interest in the real space is obtained as a plane, and it is possible to estimate a plane by which the estimated disparity map is best approximated by using the least squares method as the following Expression 3.

α=au+bv+c [Expression 3]

Where α is the obtained disparity as a plane in the disparity space. Further, a,b,c are the estimated plane parameters respectively.

Actually, in the case of using all data from the estimated disparity map, disparity estimation errors in textureless regions are reflected by the estimation results. It can be seen that disparity estimation errors occur and some points have values that deviate from the plane in the disparity map.

Therefore, in the present invention, it is possible to reduce the influence of disparity estimation errors by extracting edges in the image and estimating the plane only using disparities obtained in parts existing edges. In FIG. 10(C) points indicated in red are disparities on such edges, and it can be clearly seen that the influence of disparity estimation errors is reduced.

Here, we describe the relation between the real space and the disparity space as follows.

As described above, disparities obtained as a plane in the disparity space, can be represented by Expression 3. In this time, we consider that what kind of distribution does a plane on the disparity space (u, v, α) have in the real space (U, V, W).

The depth Z_{W} of a certain point that has a disparity α in the disparity space and exists in the real space, can be given by the following Expression 4.

$${Z}_{w} = \frac{{Z}_{0} {Z}_{1}}{α {Z}_{0} + ( 1 - α ) {Z}_{1}} \qquad [ Expression 4 ]$$

Where Z₀ and Z₁ are distances from the basis camera to calibration planes Π₀,Π₁ as shown in FIG. 9.

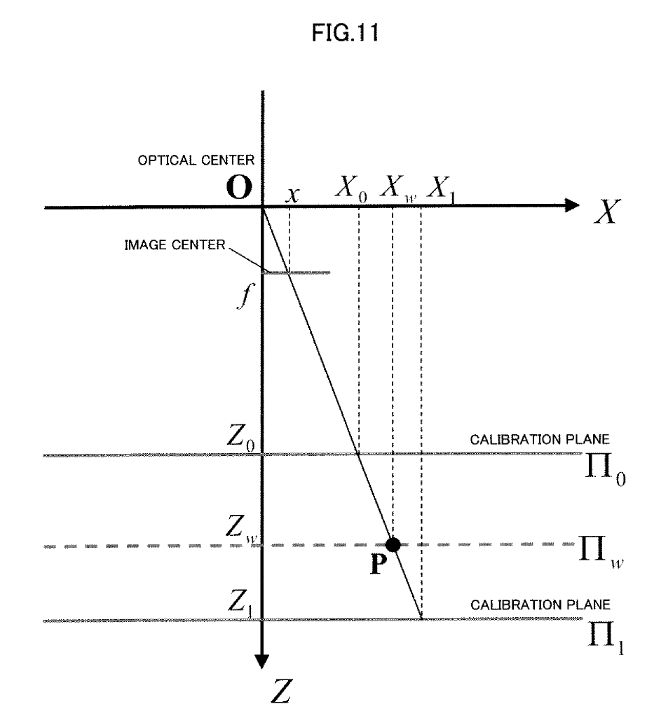

On the other hand, by considering the geometric relation in the real space that is shown in FIG. 11, with respect to X-axis coordinate X_{W} of a point P(X_{W}, Y_{W}, Z_{W}) that exists in a certain depth Z_{W}, the relation of x:f−X^{W}:Z_{W} holds.

In this time, since x is a point on the image plane, it may be considered that x∝u. Further, with respect to Y-axis, since these relations are similar too, by setting k₁ and k₂ as certain constants, the following Expression 5 is obtained.

$$\{ \begin{matrix}{X}_{w} = {k}_{1}^{′} u \cdot {Z}_{w} \\ {Y}_{w} = {k}_{2}^{′} v \cdot {Z}_{w}\end{matrix} ∴ \{ \begin{matrix}u = \frac{{k}_{1} {X}_{w}}{{Z}_{w}} \\ v = \frac{{k}_{1} {Y}_{w}}{{Z}_{w}}\end{matrix} \qquad [ Expression 5 ]$$

Here, when α is deleted by substituting Expression 3 into Expression 4, the following Expression 6 is obtained.

$${Z}_{w} = \frac{{Z}_{0} {Z}_{1}}{\begin{matrix}α ( {Z}_{0} - {Z}_{1} ) u + \\ b ( {Z}_{0} - {Z}_{1} ) v + c ( {Z}_{0} - {Z}_{1} ) + {Z}_{1}\end{matrix}} \qquad [ Expression 6 ]$$

By substituting Expression 5 into Expression 6, finally, the following Expression 7 is obtained.

$$\begin{matrix}{Z}_{w} = \frac{{Z}_{0} {Z}_{1} - {ak}_{1} ( {Z}_{0} - {Z}_{1} ) {X}_{w} - {bk}_{2} ( {Z}_{0} - {Z}_{1} ) {Y}_{w}}{c ( {Z}_{0} - {Z}_{1} ) + {Z}_{1}} \\ = {a}_{1} {X}_{w} + {a}_{2} {Y}_{w} + {a}_{3}\end{matrix} \qquad [ Expression 7 ]$$

Where Z_{w} expresses that is distributed on a plane in the real space (X, Y, Z).

That is to say, it is shown that points distributed on a plane in the disparity space are also distributed on a plane in the real space.

From this thing, estimating a virtual-focal-plane in the disparity space corresponds to estimating a virtual-focal-plane in the real space. In the present invention, although the image deformation parameters are estimated by estimating the virtual-focal-plane, these image deformation parameters can be obtained by obtaining the relation in the disparity space. Hence, the present invention obtains a virtual-focal-plane in the disparity space, and does not obtain a virtual-focal-plane in the real space.

### <2-3> Image Integrating Process in the Present Invention

Here, we explain the image integrating process in the present invention (i.e. the image integrating process of FIG. 8) more concretely.

As already described in <1-2>, the image integrating process of the present invention is a process that estimates image deformation parameters which are used to perform the deformation so that each reference image is overlapped on the basis image for the estimated virtual-focal-plane, and then generates the virtual-focal-plane image by deforming each reference image with the estimated image deformation parameters.

That is to say, in order to generate (synthesize) the virtual-focal-plane image, it is necessary to obtain the transformation that matches the coordinate system of the basis image and that of each reference image for the virtual-focal-plane.

In this time, the virtual-focal-plane is estimated as a plane in the disparity space (u, v, α), since this corresponds to a plane in the real space, it is can be seen that the transformation for overlapping two planes is represented as a homography.

That is to say, the image integrating process of the present invention is performed along the next procedure (step 1˜step 5).

Step 1: Obtain the Disparity α, Corresponding to Each Vertex (uᵢ, vᵢ) of the Region of Interest on the Basis Image

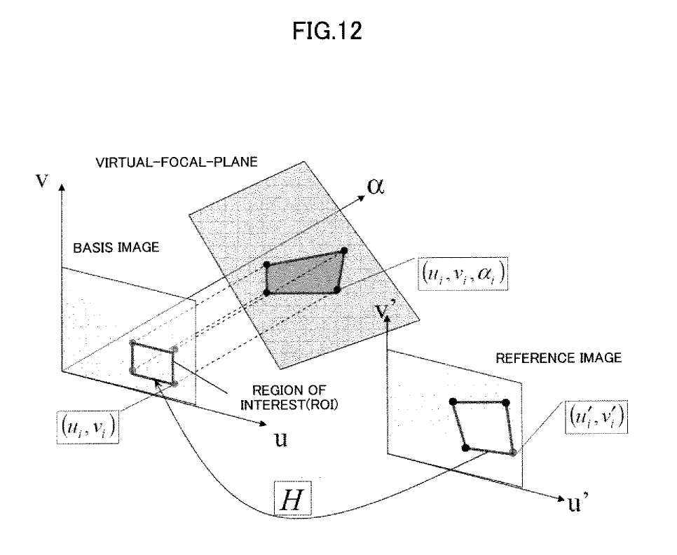

With respect to each vertex of the region of interest (the processing region) that is selected on the basis image, the processing is performed. In this embodiment, with respect to each vertex (uᵢ, vᵢ), . . . , (u₄, v₄) of the region of interest that is selected as a rectangle range, the processing is performed. In this time, as shown in FIG. 12, a virtual-focal-plane in the disparity space (u, v, α) is obtained by the virtual-focal-plane estimating process described in <2-2>. Hence, based on Expression 3 that represents the virtual-focal-plane, it is possible to obtain the disparity αᵢ corresponding to each vertex (uᵢ, vᵢ) of the region of interest.

Step 2: Obtain the Coordinate Positions of Corresponding Points of the Reference Image That Correspond to Each Vertex (uᵢ, vᵢ) of the Region of Interest on the Basis Image

From the disparity αᵢ obtained by step 1, based on Expression 1, it is possible to obtain the coordinate transformation for each vertex (uᵢ, vᵢ) of the region of interest. Hence, it is possible to obtain four pairs of correspondence relation from the disparity αᵢ to four vertices (u′ᵢ,v′ᵢ) on the reference image corresponding to four vertices (uᵢ, vᵢ) of the region of interest on the basis image.

### Step 3: Obtain a Homography Matrix That Overlaps These Coordinate Pairs From the Correspondence Relation of Two Vertices

A relation expression for the homography between images is represented by the following Expression 8.

\tilde{m}˜H [symbol] [Expression 8]

In this time, the homography matrix H is a 3×3 matrix and has eight degrees of freedom. From this thing, it is fixed as h₃₃=1, by using a vector h=(h₁₁,h₁₂,h₁₃,h₂₁,h₂₂,h₁₃,h₃₁,h₃₂)^{T} that writes elements of H, it is possible to arrange Expression 8 as the following Expression 9.

$$( \begin{matrix}u & v & 1 & 0 & 0 & 0 & - {uu}^{′} & - {u}^{′} v \\ 0 & 0 & 0 & u & v & 1 & - {uv}^{′} & - {vv}^{′}\end{matrix} ) h = ( \begin{matrix}{u}^{′} \\ {v}^{′}\end{matrix} ) \qquad [ Expression 9 ]$$

Where \tilde{m}=(u,v,1)^{T} and [symbol] =(u′,v′,1)^{T} hold. Further, \tilde{m} represents homogenous coordinates of coordinates m in the basis image. [symbol] represents homogenous coordinates of coordinates m′ in the reference image. Moreover, the symbol ˜ represents an equivalence relation, and means that both sides permit the difference of the constant factor and are equal.

If four or more pairs of the correspondence relation of \tilde{m} and [symbol] are given, it is possible to solve Expression 9 with respect to h. From this thing, it is possible to obtain the homography matrix H by using the correspondence relation of two vertices.

### Step 4: Obtain the Homography Matrix H

With respect to all reference images, processes of step 2 and step 3 are performed, and the homography matrix H that gives the transformation for overlapping two planes is obtained. Further, the obtained homography matrices H are a specific example of “the image deformation parameters” saying in the present invention. Moreover, it is possible to set parameters capable of perform the deformation so that each interference image is overlapped on the basis image as the image deformation parameters of the present invention.

### Step 5: Generate the Virtual-Focal-Plane Image by Deforming Each Reference Image to the Basis Image and Performing the Image Integrating Process

By using homography matrices H obtained by step 1˜step 4, it is possible to perform the deformation so that the region of interest on each reference image is overlapped on the region of interest on the basis image. That is to say, by performing the deformation for the reference image, with respect to the region of interest, it is possible to perform the deformation so that multiple images captured from multiple view points are overlapped on an image and integrates the deformed multiple images. In a word, it is possible to synthesize the virtual-focal-plane image by integrating multiple images into an image.

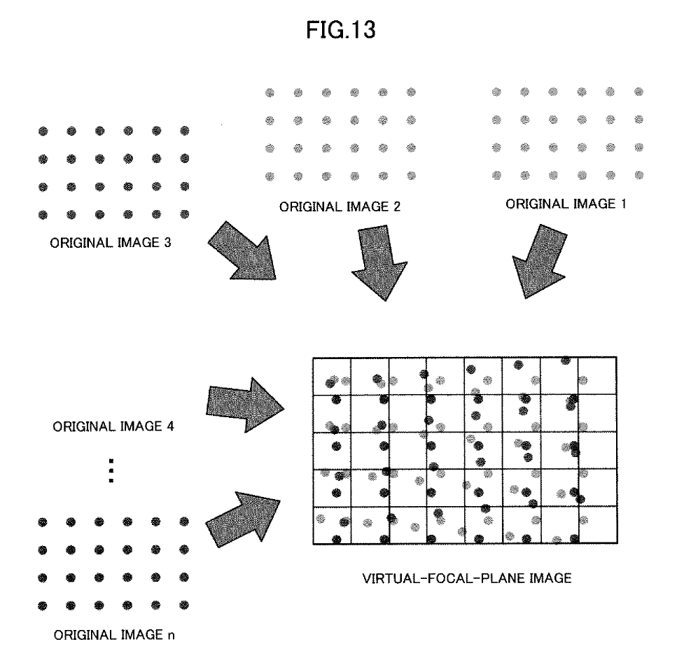

Specifically, in the present invention, since the disparity is obtained with sub-pixel accuracy, as conceptually shown in FIG. 13, it is possible to project pixels of each of original images consisting of multi-view images (i.e. each reference image) with sub-pixel accuracy, and then combine and integrate the projected pixels.

And then, as shown in FIG. 13, by sectioning the integrated pixel group with a lattice having an arbitrary size and generating an image in which this lattice is set as a pixel, it is possible to obtain an image with an arbitrary resolution. The pixel value that is assigned to each sectioned lattice, is obtained by averaging pixel values of pixels that are included in each lattice and are projected from each reference image. With respect to lattices that do not include the projected pixel, the pixel values are assigned by interpolation.

In this way, it is possible to synthesize the virtual-focal-plane image with an arbitrary resolution. That is to say, it goes without saying that according to the present invention, it is possible to easily generate the virtual-focal-plane image with a resolution higher than multi-view images, i.e. the high-resolution virtual-focal-plane image.

### <3> Experimental Results

In order to verify the superior effect of the present invention to be capable of simply and rapidly generating the virtual-focal-plane image with a resolution higher than multi-view images by using multi-view images, by using the synthesized stereo images and real multi-camera images as multi-view images respectively, we performed experiments that synthesize the virtual-focal-plane image based on the method for generating a high-resolution virtual-focal-plane image of the present invention. We show the experimental results of these experiments as follows.

### <3-1> Experiment Using the Synthesized Stereo Images

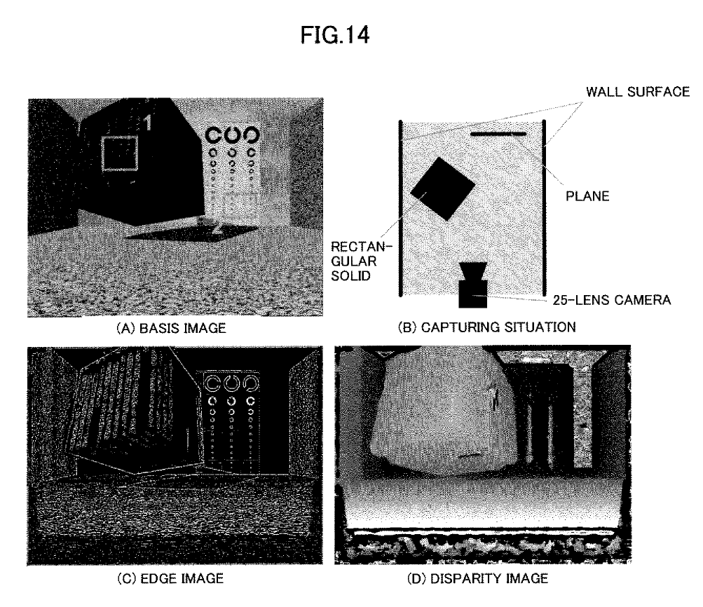

FIG. 14 illustrates setting conditions of the experiment using the synthesized stereo images. As shown in the capturing situation of FIG. 14(B), the synthesized stereo images are images that assume the capturing of a wall surface, a plane that faces the camera and a rectangular solid by using a 25-lens camera.

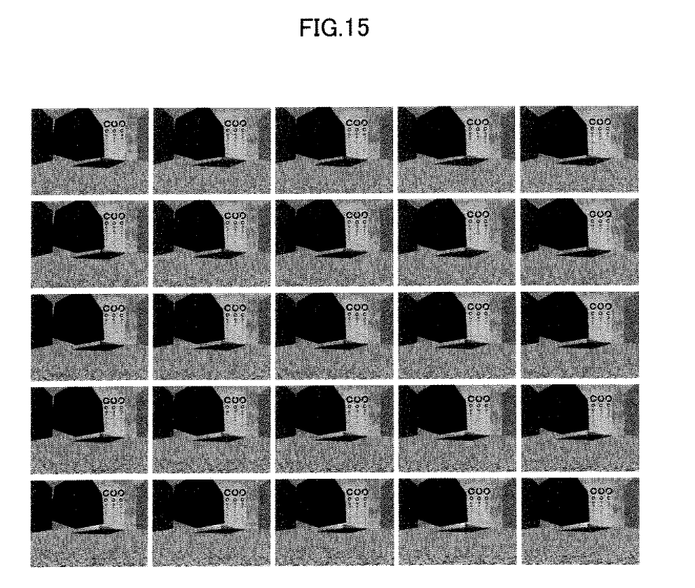

FIG. 15 shows the all synthesized images (the synthesized stereo images). Further, the basis image that is selected from the synthesized stereo images shown in FIG. 15, is magnified and is shown in FIG. 14(A). Moreover, rectangle regions 1 and 2 of FIG. 14(A) are the processing regions (regions of interest) designated by the user, respectively. Further, in this experiment, 25 cameras are arranged in the shape of the lattice of the equal interval of 5×5 and the experiment is carried out.

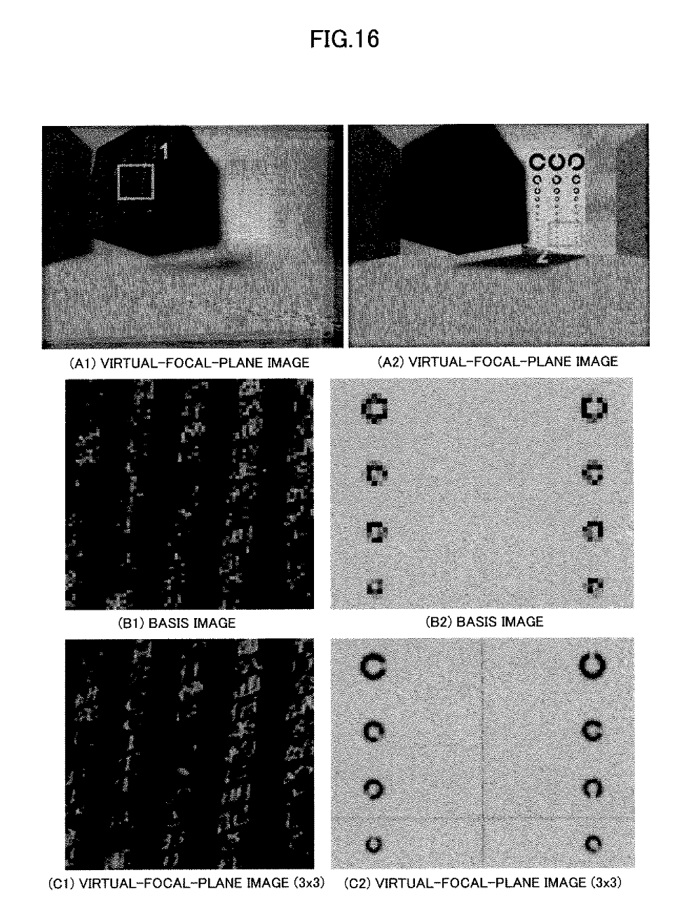

FIG. 16 shows the results of experiments using the synthesized stereo images shown in FIG. 15. FIG. 16(A1) and FIG. 16(A2) are the virtual-focal-plane images corresponding to regions of interest 1 and 2 of FIG. 14(A), respectively.

From the virtual-focal-plane images shown in FIG. 16(A1) and FIG. 16(A2), it can be clearly seen that the plane existing in each region of interest (each processing region) comes into focus and other region obtains a blurred image. Specifically, in FIG. 16(A1), it can be seen that the focal plane exists diagonally, and one side of the rectangular solid in space and the floor face of its extension line come into focus.

On the other hand, FIG. 16(B1) and FIG. 16(B2) show region of interest 1 and region of interest 2 in the basis image respectively. Further, FIG. 16(C1) and FIG. 16(C2) are the virtual-focal-plane images obtained by the high-resolution processing with 3×3 magnification. By comparing these images, it can be seen that the image quality of each image is improved by the high-resolution processing realized based on the present invention.

### <3-2> Experiment Using Real Multi-Camera Images

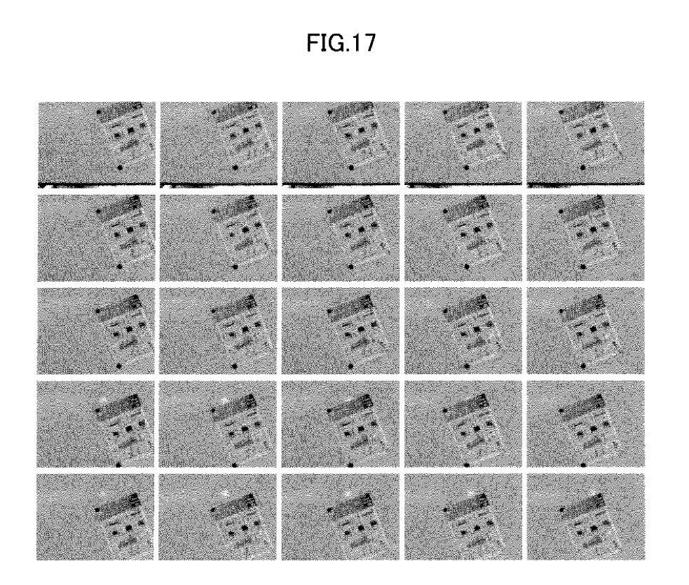

FIG. 17 shows 25 real images that are used in the experiment using real multi-camera images. The real multi-camera images shown in FIG. 17, are images that are captured by 25 assumed cameras arranged in the shape of the lattice of 5×5 after fixing a camera on a translation stage.

By the way, the interval between cameras is 3 cm. Further, the camera is a single CCD camera using the Bayer color pattern, and the lens distortion is corrected by bilinear interpolation after performing a calibration separately from the calibration using two planes.

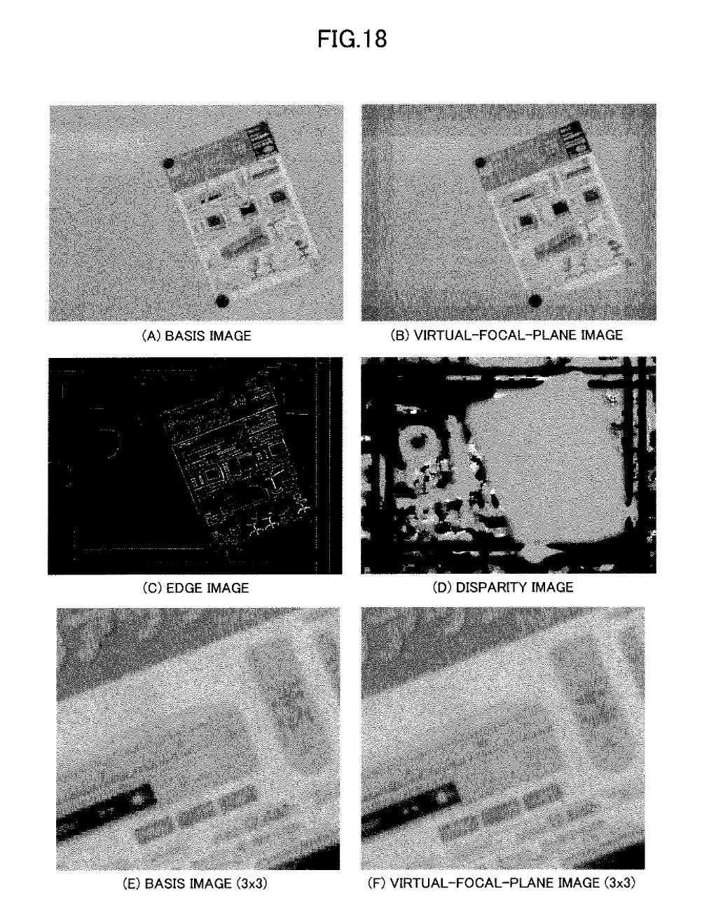

FIG. 18 shows the results of experiments using real multi-camera images shown in FIG. 17. FIG. 18(A) shows the basis image and the region of interest (a rectangle range indicated by a green solid line). FIG. 18(B) shows the synthesized virtual-focal-plane image. Further, FIG. 18(E) is an image obtained by magnifying the region of interest (the processing region) in the basis image. FIG. 18(F) is the virtual-focal-plane image obtained by the high-resolution processing with 3×3 magnification for the region of interest.

By comparing these images, it can be clearly seen that the noise component included in the image is considerably reduced. Further, because the legibility of characters in the image is improved and the finespun textures information is obtained more clearly, it is also possible to confirm the effect of the high-resolution processing based on the present invention.

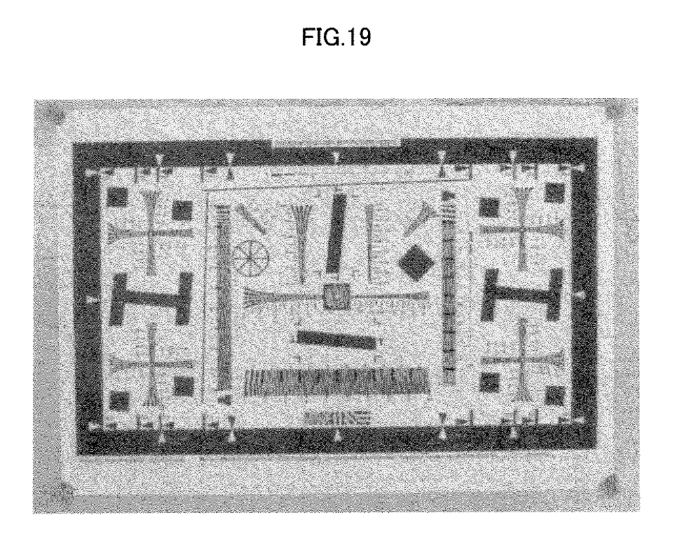

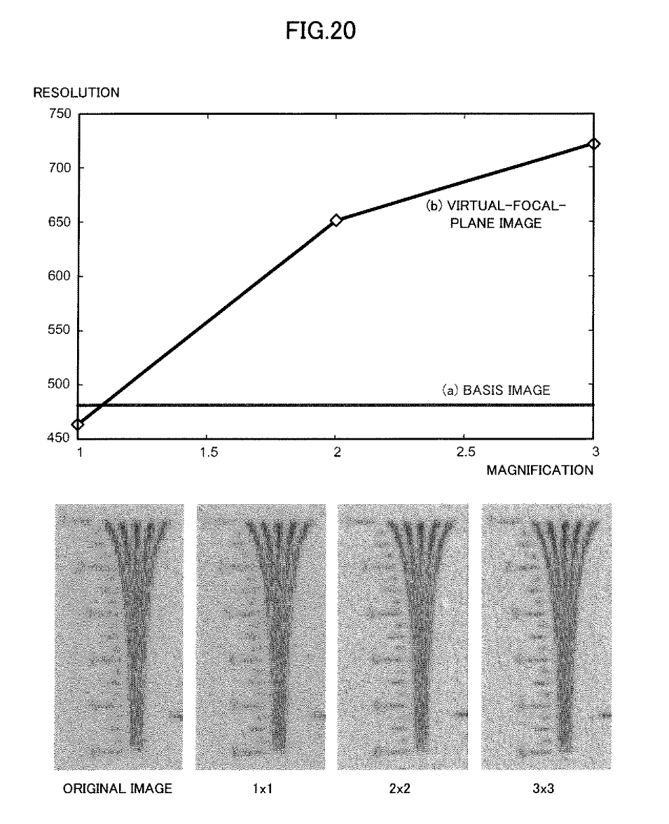

FIG. 20 is an experimental result obtained by performing the resolution measurement based on CIPA DC-003 (see Non-Patent Document 8) by using a camera arrangement same as the camera arrangement by which real multi-camera images shown in FIG. 17 are captured. This standard computes the effective resolution of a digital camera by obtaining the number of resolution lines of the wedge on the ISO 12233 resolution test chart that is captured by the digital camera. FIG. 19 shows one piece of central image among the captured real 25-camera images. By using the method of the present invention, the resolution of the wedge on the image is improved.

In FIG. 20, by comparing images, it is possible to confirm that the resolutions are improved respectively with an image having 2×2 magnification than the original image and an image having 3×3 magnification than the original image. Further, the vertical axis of the graph of FIG. 20 represents the resolution that is measured by using the resolution measurement method, and the horizontal axis of the graph of FIG. 20 represents the magnification. From the graph of FIG. 20, it can be clearly seen that with the increase of the magnification, the resolution is improved greatly. This quantitatively confirms that the present invention is also effective for the high-resolution processing. That is to say, it is confirmed that in the virtual-focal-plane image generated by the present invention, an image with the desired high image quality for the region of interest is obtained from original images by the experiments.

### INDUSTRIAL APPLICABILITY

The method for generating a high-resolution virtual-focal-plane image according to the present invention, is a method capable of generating a virtual-focal-plane image with the desired arbitrary resolution simply and rapidly by using multi-view images captured from multiple different viewpoints for a capturing object.

In the conventional method disclosed in Non-Patent Document 6, when the user adjusts the focal plane to the desired plane, it is necessary to sequentially adjust parameters till the virtual-focal-plane image that the user can be satisfied with is obtained. On the other hand, by using the present invention, the burden of the user when the virtual-focal-plane image is generated, is considerably reduced, that is to say, in the present invention, the operation of the user becomes only the operation to designate the region of interest from an image.

Further, since the virtual-focal-plane image generated by the present invention capable of having an arbitrary resolution, according to the present invention, it is possible to play a superior effect capable of generating an image with a resolution that is higher than original images (multi-view images).

That is to say, it is possible to obtain the effects of the image quality improvement such as noise reduction and image resolution improvement in the region of interest on the image.

### THE LIST OF REFERENCES

Non-Patent Document 1:
Park S. C., Park M. K. and Kang M. G., “Super-resolution image reconstruction: a technical overview”, IEEE Signal Processing Magazine), Vol. 20, No. 3, p. 21-36, 2003.
Non-Patent Document 2:
K. Ikeda, M. Shimizu and M. Okutomi, “Simultaneous Improvement of Image Quality and depth estimation Using Stereo Images”, IPSJ Transactions on Computer Vision and Image Media, Vol. 47, No. NSIG9 (CVIM14), p. 111-114, 2006.
Non-Patent Document 3:
Okutomi M. and Kanede T., “A multiple baseline stereo”, IEEE Trans. on PAMI, Vol. 15, No. 4, p. 353-363, 1993.
Non-Patent Document 4:
Shimizu M. and Okutomi M., “Sub-pixel Estimation Error Cancellation on Area-Based Matching”, International Journal of Computer Vision, Vol. 63, No. 3, p. 207-224, 2005.
Non-Patent Document 5:
Wilburn B., Joshi N., Vaish V., Talvala E.-V., Antunez E., Barth A., Adams A., Horowitz M. and Levoy M., “High performance imaging using large camera arrays”, ACM Transactions on Graphics, Vol. 24, No. 3, p. 765-776, 2005.
Non-Patent Document 6:
Vaish V., Garg G., Talvala E.-V., Antunez E., Wilburn B., Horowitz M. and Levoy, M., “Synthetic Aperture Focusing using a Shear-Warp Factorization of the Viewing Transform”, CVPR, Vol. 3, p. 129-129, 2005.
Non-Patent Document 7:
Kano H. and Kanade T., “A Stereo Method with Arbitrary Positioned Cameras and Stereo Camera Calibration”, The transactions of the Institute of Electronics, Information and Communication Engineers, Vol. J79-D-2, No. 11, p. 1810-1818, 1996.
Non-Patent Document 8:
Standardization Committee of Camera & Imaging Products Association, “Resolution Measurement Methods for Digital Cameras”, CIPA DC-003.

1. A method for generating a high-resolution virtual-focal-plane image which generates a virtual-focal-plane image by using one set of multi-view images consisting of multiple images obtained from multiple different view points, said method characterized in that
with respect to an arbitrary predetermined region, said virtual-focal-plane image is generated by performing a deformation so that each image of said multi-view images overlaps.

2. The method for generating a high-resolution virtual-focal-plane image according to claim 1, wherein disparities are obtained by performing the stereo matching for said multi-view images, and said deformation are obtained by using said obtained disparities.

3. The method for generating a high-resolution virtual-focal-plane image according to claim 2, wherein said deformation utilizes a two-dimensional homography for overlapping two images.

4. The method for generating a high-resolution virtual-focal-plane image according to claim 3, wherein said deformation is performed for said multiple images. Consisting of said multi-view images, said deformed multiple images are integrated, an integrated pixel group is sectioned with a lattice having an arbitrary size, said virtual-focal-plane image with an arbitrary resolution is generated by setting said lattice as a pixel.

5. A method for generating a high-resolution virtual-focal-plane image which generates a virtual-focal-plane image by using one set of multi-view images consisting of multiple images captured from multiple different view points for a capturing object, said method comprising.
A disparity estimating process step for estimating disparities by performing the stereo matching for said multi-view images and obtaining a disparity image;
a region selecting process step for selecting an image among said multiple images consisting of said multi-view images as a basis image, setting all remaining images except said basis image as reference images, and selecting a predetermined region on said basis image as a region of interest;
a virtual-focal-plane estimating process step for estimating a plane in the disparity space for said region of interest based on said disparity image, and setting said estimated plane as a virtual-focal-plane; and
an image integrating process step for obtaining image deformation parameters that are used for deforming said each reference image to said basis image for said virtual-focal-plane, and generating said virtual-focal-plane image by deforming said multi-view images with said obtained image deformation parameters.

6. The method for generating a high-resolution virtual-focal-plane image according to claim 5, wherein said multi-view images are obtained by a camera group that consists of multiple cameras and has a two-dimensional arrangement.

7. The method for generating a high-resolution virtual-focal-plane image according to claim 5, wherein an image capture device is fixed on a moving means, said multi-view images are images captured by moving said image capture device after assuming a camera group that consists of multiple cameras and has a two-dimensional arrangement.

8. The method for generating a high-resolution virtual-focal-plane image according to claim 5, wherein in said virtual-focal-plane estimating process step, edges in the image belonging to said region of interest of said basis image are extracted, a plane in the disparity space for said region of interest is estimated by only using disparities obtained in parts existing at said edges, and said estimated plane is set as said virtual-focal-plane.

9. The method for generating a high-resolution virtual-focal-plane image according to claim 5, wherein said image integrating process step comprises
a first step for obtaining the disparity corresponding to each vertex of said region of interest on said basis image;
a second step for obtaining coordinate positions of corresponding points of said reference image that correspond to each vertex of said region of interest on said basis image;
a third step for obtaining a homography matrix that overlaps these coordinate pairs from the correspondence relation of two vertices;
a fourth step for obtaining said homography matrix that gives the transformation for overlapping two planes by performing processes of said second step and said third step with respect to all reference images; and
a fifth step for performing the image integrating process by deforming each reference image with the obtained homography matrix, sectioning the integrated pixel group with a lattice having a predetermined size, and generating said virtual-focal-plane image with a resolution determined by said predetermined size of said lattice by setting said lattice as a pixel.

10. The method for generating a high-resolution virtual-focal-plane image according to claim 6, wherein in said virtual-focal-plane estimating process step, edges in the image belonging to said region of interest of said basis image are extracted, a plane in the disparity space for said region of interest is estimated by only using disparities obtained in parts existing at said edges, and said estimated plane is set as said virtual-focal-plane.

11. The method for generating a high-resolution virtual-focal-plane image according to claim 7, wherein in said virtual-focal-plane estimating process step, edges in the image belonging to said region of interest of said basis image are extracted, a plane in the disparity space for said region of interest is estimated by only using disparities obtained in parts existing at said edges, and said estimated plane is set as said virtual-focal-plane.

12. The method for generating a high-resolution virtual-focal-plane image according to claim 5, wherein said image integrating process step comprises
a first step for obtaining the disparity corresponding to each vertex of said region of interest on said basis image;
a second step for obtaining coordinate positions of corresponding points of said reference image that correspond to each vertex of said region of interest on said basis image;
a third step for obtaining a homography matrix that overlaps these coordinate pairs from the correspondence relation of two vertices;
a fourth step for obtaining said homography matrix that gives the transformation for overlapping two planes by performing processes of said second step and said third step with respect to all reference images; and
a fifth step for performing the image integrating process by deforming each reference image with the obtained homography matrix, sectioning the integrated pixel group with a lattice having a predetermined size, and generating said virtual-focal-plane image with a resolution determined by said predetermined size of said lattice by setting said lattice as a pixel.

13. The method for generating a high-resolution virtual-focal-plane image according to claim 6, wherein said image integrating process step comprises
a first step for obtaining the disparity corresponding to each vertex of said region of interest on said basis image;
a second step for obtaining coordinate positions of corresponding points of said reference image that correspond to each vertex of said region of interest on said basis image;
a third step for obtaining a homography matrix that overlaps these coordinate pairs from the correspondence relation of two vertices;
a fourth step for obtaining said homography matrix that gives the transformation for overlapping two planes by performing processes of said second step and said third step with respect to all reference images; and
a fifth step for performing the image integrating process by deforming each reference image with the obtained homography matrix, sectioning the integrated pixel group with a lattice having a predetermined size, and generating said virtual-focal-plane image with a resolution determined by said predetermined size of said lattice by setting said lattice as a pixel.

14. The method for generating a high-resolution virtual-focal-plane image according to claim 7, wherein said image integrating process step comprises
a first step for obtaining the disparity corresponding to each vertex of said region of interest on said basis image;
a second step for obtaining coordinate positions of corresponding points of said reference image that correspond to each vertex of said region of interest on said basis image;
a third step for obtaining a homography matrix that overlaps these coordinate pairs from the correspondence relation of two vertices;
a fourth step for obtaining said homography matrix that gives the transformation for overlapping two planes by performing processes of said second step and said third step with respect to all reference images; and
a fifth step for performing the image integrating process by deforming each reference image with the obtained homography matrix, sectioning the integrated pixel group with a lattice having a predetermined size, and generating said virtual-focal-plane image with a resolution determined by said predetermined size of said lattice by setting said lattice as a pixel.

15. The method for generating a high-resolution virtual-focal-plane image according to claim 8, wherein said image integrating process step comprises
a first step for obtaining the disparity corresponding to each vertex of said region of interest on said basis image;
a second step for obtaining coordinate positions of corresponding points of said reference image that correspond to each vertex of said region of interest on said basis image;
a third step for obtaining a homography matrix that overlaps these coordinate pairs from the correspondence relation of two vertices;
a fourth step for obtaining said homography matrix that gives the transformation for overlapping two planes by performing processes of said second step and said third step with respect to all reference images; and
a fifth step for performing the image integrating process by deforming each reference image with the obtained homography matrix, sectioning the integrated pixel group with a lattice having a predetermined size, and generating said virtual-focal-plane image with a resolution determined by said predetermined size of said lattice by setting said lattice as a pixel.
